(19) United States
(12) Patent Application Publication
(10) Pub. No.: US 2023/0385597 A1
(43) Pub. Date: Nov. 30, 2023

(54) MULTI-GRANULARITY PERCEPTION INTEGRATED LEARNING METHOD, DEVICE, COMPUTER EQUIPMENT AND MEDIUM

(71) Applicant: National University of Defense Technology, Changsha (CN)

(72) Inventors: Xianqiang ZHU, Changsha (CN); Xueqin HUANG, Changsha (CN); Cheng ZHU, Changsha (CN); Xianghan WANG, Changsha (CN); Bin LIU, Changsha (CN); Yun ZHOU, Changsha (CN); Zhaoyun DING, Changsha (CN); Yuanyuan GUO, Changsha (CN)

(21) Appl. No.: 18/184,767

(22) Filed: Mar. 16, 2023

(30) Foreign Application Priority Data
May 27, 2022 (CN) 202210590822.4

(51) Int. Cl. G06N 3/006; H04L 67/50

(52) U.S. Cl. CPC G06N 3/006; H04L 67/535

(57) ABSTRACT

Disclosed are a multi-granularity perception integrated learning method, a device, a computer equipment and a storage medium. The method includes following steps: preprocessing a data set of users' online behaviors, performing multi-granularity perception processing on preprocessed data set according to the characteristic category of the attribute characteristics and the particle label values by the multi-granularity perception data derivation algorithm to obtain the multi-granularity perception data set; dividing multi-granularity perception data set by granular layer to obtain the multi-level derivative data set; training preset base learners; inputting the training data set into the trained base learner, calculating the self-prediction error, and determining the weight information; inputting the testing data set into the trained base learner to obtain the prediction results of the testing data set, and weighting and integrating prediction results to output the multi-granularity perception integrated learning prediction results of the online behaviors data of the users.

### CROSS-REFERENCE TO RELATED APPLICATIONS

This application claims priority to Chinese Patent Application No. 202210590822.4, filed on May 27, 2022, the contents of which are hereby incorporated by reference.

### TECHNICAL FIELD

The application relates to the technical field of computers, and in particular to a multi-granularity perception integrated learning method, a device, a computer equipment and a storage medium aiming at data analysis of the online behaviors of users.

### BACKGROUND

With the wide application of Internet in many practical fields, such as information security, economic management, social governance, medical biology and so on, more and more data are produced to record users' online behavior information. How to extract knowledge and mine data from users' online behavior data more effectively and accurately to meet the actual needs is still facing a lot of tests. However, there are few application researches on the data of users' online behavior combining granular computing and ensemble learning. Users' online behavior data belongs to structured data, which is easy to query, modify and calculate, which may usually abstract a higher level of data. This abstract process is called granulation, and multi-granularity perception is a granulation conversion method on the data to different degrees for many times, thus generating abstract multi-granularity characteristics, so as to achieve the objective of multi-level and multi-perspective perception of data. From the perspective of cognitive computing, multi-granularity perception is the concept learning based on granular computing, which is beneficial to conceptual knowledge. At present, how to make users' online behavior data reasonably multi-granularity and how to carry out efficient, accurate and interpretable integrated learning on multi-granularity structured data have rarely been studied systematically, so it is very valuable and necessary to carry out the research on multi-granularity awareness integrated learning method of users' online behavior data.

### SUMMARY

Based on this, it is necessary to provide a multi-granularity perception integrated learning method, device, computer equipment and storage medium that may apply the granular computing theory to the analysis of users' online behavior.

The application relates to a multi-granularity perception integrated learning method, including following steps:
obtaining a data set of a user's online behavior, and preprocessing the data set to obtain a preprocessed data set; the data in the preprocessed data set includes attribute characteristics, granularity characteristics and particle lab el values;
inputting the preprocessed data set into a pre-designed multi-granularity perception data derivation algorithm, and performing a multi-granularity perception processing on the preprocessed data set according to a characteristic category of the attribute characteristics and the particle label values by the multi-granularity perception data derivation algorithm to obtain a multi-granularity perception data set; dividing the multi-granularity perception data set by a granular layer according to the granularity characteristics to obtain a multi-level derivative data set; the derivative data set is divided into a training data set and a testing data set; the data in the derivative data set include derivative attribute values and the particle label values of corresponding granular layers;
training a plurality of preset base learners according to the derivative attribute values of the training data set data and the particle label values of the corresponding granular layers to obtain a trained base learner based on a base learning algorithm; a number of the base learners is the same as a number of layers of the derivative data set;
inputting the training data set into the trained base learner, calculating a self-prediction error of the testing data set predicted by the trained base learner, and counting a mean square error with particle as unit and a mean square error with granular layer as unit according to the self-prediction error;
obtaining a particle-level weight according to the mean square error with particle as unit, obtaining a granularity-level weight according to the mean square error with granular layers as unit, and determining weight information according to the particle-level weight and the granularity-level weight; wherein, the smaller of the values of the particles or granular layers, the larger the weight values; and
inputting the testing data set into the trained base learner to obtain prediction results of the testing data set, performing weighted integration on the prediction results according to the weight information, and outputting a multi-granularity perception integrated learning prediction results for the user's online behavior data.

In one embodiment, the method further includes:
obtaining the data set of the user's online behavior, and preprocessing the data set;
generating the attribute characteristics, the granularity characteristics and the particle label values of data according to attributes in the data structure of the data set to obtain the preprocessed data set; the attributes in the data structure of the data set is an account, a department and a company to which the data belongs;
or generating the attribute characteristics, the granularity characteristics and the particle label values of data according to the data set through a hierarchical clustering method to obtain the preprocessed data set.

In one embodiment, the method further includes:
inputting the preprocessed data set into the pre-designed multi-granularity perception data derivation algorithm;
taking the particle label values as one of the attribute characteristics, judging the attribute characteristics of the preprocessed data; if the attribute characteristics are numerical characteristics, performing an intra-granular normalization on the numerical characteristics, and if the attribute characteristics are symbolic characteristics, performing an intra-granular recoding on the symbolic characteristics; and
obtaining the multi-granularity perception data set.

In one embodiment, the method further includes:
dividing the multi-granularity perception data set into a multi-granularity training set and a multi-granularity testing set; and
dividing the multi-granularity training set and the multi-granularity testing set according to the granularity characteristics to obtain a multi-level training data set and a multi-level testing data set respectively; the training data set and the testing data set constitute the derivative data set.

In one embodiment, the method further includes:
enhancing the weight information through a particle swarm algorithm to obtain enhanced weight information;
inputting the testing data set into the trained base learner to obtain the prediction results of the testing data set; and
performing the weighted integration on the prediction results according to the enhanced weight information.

In one embodiment, the method further includes:
taking the weight information as an initial value of the particle swarm algorithm;

repeatedly performing an iteration the particle swarm algorithm according to the initial value until an end condition is met, and ending the iteration; and
obtaining the enhanced weight information.

In one embodiment, the method further includes that the base learner is a tree model.

A multi-granularity perception integrated learning device, including:
a preprocessing module is used for obtaining the data set of the online behaviors of users and preprocessing the data set to obtain the preprocessed data set; the data in the preprocessed data set includes the attribute characteristics, the granularity characteristics and the particle label values;
a data derivation module is use for inputting the preprocessed data set into the pre-designed multi-granularity perception data derivation algorithm, and performing the multi-granularity perception processing on the preprocessed data set according to the characteristic category of the attribute characteristics and the particle label values by the multi-granularity perception data derivation algorithm to obtain the multi-granularity perception data set; dividing the multi-granularity perception data set by the granular layer according to the granularity characteristics to obtain the multi-level derivative data set; the derivative data set is divided into the training data set and the testing data set; the data in the derivative data set include the derivative attribute values and the particle label values of the corresponding granular layers;
a base learner training module is used for training a plurality of preset base learners according to the derivative attribute values of the training data set data and the particle label values of the corresponding granular layers to obtain the trained base learner based on the base learning algorithm; the number of the base learners is the same as the number of layers of the derivative data set;
a mean square error statistics module is used for inputting the training data set into the trained base learner, calculating the self-prediction error of the testing data set predicted by the trained base learner, and counting the mean square error with the particle as the unit and the mean square error with the granular layer as the unit according to the self-prediction error;
a weight information determining module is used for obtaining the particle-level weight according to the mean square error with the particle as the unit, obtaining the granularity-level weight according to the mean square error with the granular layers as the unit, and determining the weight information according to the particle-level weight and the granularity-level weight; wherein, the smaller of the values of the particles or granular layers, the larger the weight values; and
a multi-granularity perception integrated learning prediction module is used for inputting the testing data set into the trained base learner to obtain the prediction results of the testing data set, and performing the weighted integration on the prediction results according to the weight information, and outputting the multi-granularity perception integrated learning prediction results for the user's online behavior data.

A computer device includes a memory and a processor, wherein the memory stores a computer program, and when the processor executes the computer program, the following steps are realized:
obtaining the data set of the online behaviors of users and preprocessing the data set to obtain the preprocessed data set; the data in the preprocessed data set includes the attribute characteristics, the granularity characteristics and the particle lab el values;
inputting the preprocessed data set into the pre-designed multi-granularity perception data derivation algorithm, and performing the multi-granularity perception processing on the preprocessed data set according to the characteristic category of the attribute characteristics and the particle label values by the multi-granularity perception data derivation algorithm to obtain the multi-granularity perception data set; dividing the multi-granularity perception data set by the granular layer according to the granularity characteristics to obtain the multi-level derivative data set; the derivative data set is divided into the training data set and the testing data set; the data in the derivative data set include the derivative attribute values and the particle label values of the corresponding granular layers;
training a plurality of preset base learners according to the derivative attribute values of the training data set data and the particle label values of the corresponding granular layers to obtain the trained base learner based on the base learning algorithm; the number of the base learners is the same as the number of layers of the derivative data set;
inputting the training data set into the trained base learner, calculating the self-prediction error of the testing data set predicted by the trained base learner, and counting the mean square error with the particle as the unit and the mean square error with the granular layer as the unit according to the self-prediction error;
obtaining the particle-level weight according to the mean square error with the particle as the unit, obtaining the granularity-level weight according to the mean square error with the granular layers as the unit, and determining the weight information according to the particle-level weight and the granularity-level weight; wherein, the smaller of the values of the particles or granular layers, the larger the weight values; and
inputting the testing data set into the trained base learner to obtain the prediction results of the testing data set, and performing the weighted integration on the prediction results according to the weight information, and outputting the multi-granularity perception integrated learning prediction results for the user's online behavior data.

A computer-readable storage medium has a computer program stored thereon, and the computer program may realize the following steps when executed by a processor:
obtaining the data set of the online behaviors of users and preprocessing the data set to obtain the preprocessed data set; the data in the preprocessed data set includes the attribute characteristics, the granularity characteristics and the particle lab el values;
inputting the preprocessed data set into the pre-designed multi-granularity perception data derivation algorithm, and performing the multi-granularity perception processing on the preprocessed data set according to the characteristic category of the attribute characteristics and the particle label values by the multi-granularity perception data derivation algorithm to obtain the multi-granularity perception data set; dividing the multi-granularity perception data set by the granular layer according to the granularity characteristics to obtain the multi-level derivative data set; the derivative data set is divided into the training data set and the testing data set; the data in the derivative data set include the derivative attribute values and the particle label values of the corresponding granular layers;
training a plurality of preset base learners according to the derivative attribute values of the training data set data and the particle label values of the corresponding granular layers to obtain the trained base learner based on the base learning algorithm; the number of the base learners is the same as the number of layers of the derivative data set;
inputting the training data set into the trained base learner, calculating the self-prediction error of the testing data set predicted by the trained base learner, and counting the mean square error with the particle as the unit and the mean square error with the granular layer as the unit according to the self-prediction error;
obtaining the particle-level weight according to the mean square error with the particle as the unit, obtaining the granularity-level weight according to the mean square error with the granular layers as the unit, and determining the weight information according to the particle-level weight and the granularity-level weight; wherein, the smaller of the values of the particles or granular layers, the larger the weight values; and
inputting the testing data set into the trained base learner to obtain the prediction results of the testing data set, and performing the weighted integration on the prediction results according to the weight information, and outputting the multi-granularity perception integrated learning prediction results for the user's online behavior data.

The multi-granularity perception integrated learning method, device, computer equipment and storage medium preprocess the data set of users' online behavior; through the multi-granularity perception data derivation algorithm, the attribute characteristics are processed with particle as unit, and then the data are divided into granular layers according to the granularity characteristics to obtain multi-level derivative data sets; based on the base learning algorithm, a plurality of preset base learners are trained according to the derivative attribute values of the training data set data in the derivative data set and the particle label values of the corresponding granular layers, and the trained base learners are obtained; inputting the training data set into the trained base learner, calculating the self-prediction error, and counting the mean square error with the particle as the unit and the mean square error with the granular layer as the unit; determining the weight information according to the error of particles and granular layers; wherein, the smaller of the values of the particles or granular layers, the larger the weight values; inputting the testing data set into the trained base learner to obtain the prediction results of the testing data set, and then carrying out weighted integration on the prediction results according to the weight information to output the multi-granularity perception integrated learning prediction results of the user's online behavior data. According to the user's online behavior data, the application proposes to transform the user's online behavior data from particle visual field and particle layer perspective to derive a plurality of data sets with different visual fields, and divides the weights into two levels through weighted integration strategy: granular layer and particle, thus improving the interpretability of the user's online behavior analysis and the accuracy of the prediction results.

### BRIEF DESCRIPTION OF THE DRAWINGS

FIG. 1 is a flow diagram of a multi-granularity perception integrated learning method in one embodiment.

FIG. 2 is a schematic diagram of the derivative data style output by the multi-granularity perception data derivation algorithm in one embodiment.

FIG. 3 is a flowchart of a multi-granularity perceptionsing derivative algorithm in one embodiment.

FIG. 4 is a schematic diagram of a weighted integration strategy in one embodiment.

FIG. 5 is a flowchart of a multi-granularity perception integrated learning method in another embodiment.

FIG. 6 is an experimental result in a specific embodiment.

FIG. 7 is a structural block diagram of a multi-granularity perception integrated learning device in one embodiment.

FIG. 8 is an internal structure diagram of a computer device in one embodiment.

### DETAILED DESCRIPTION OF THE EMBODIMENTS

In order to make the objective, technical scheme and advantages of this application clearer, the application will be further described in detail with the attached drawings and embodiments. It should be understood that the specific embodiments described herein are only used to explain the application, and are not used to limit the application.

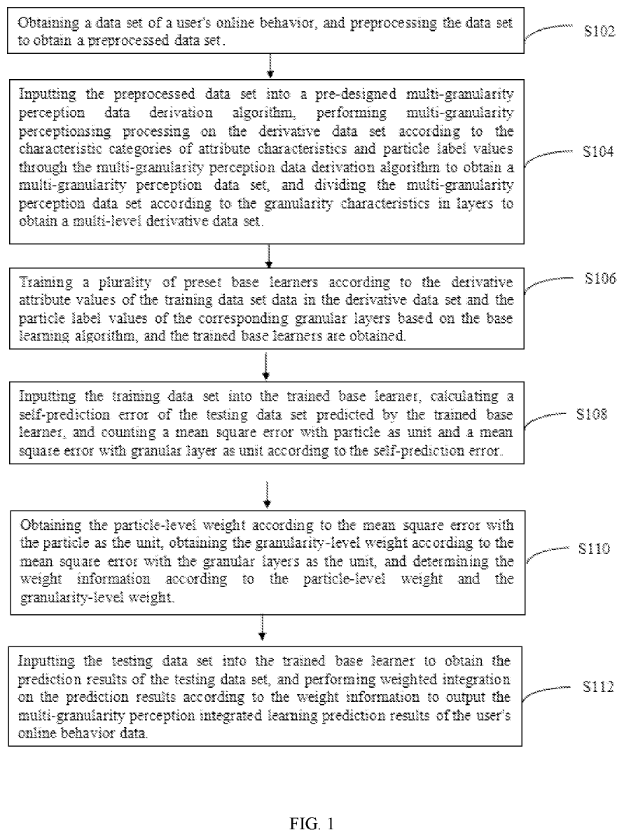

In one embodiment, as shown in FIG. 1, a multi-granularity perception integrated learning method is provided, including following steps:
S102, obtaining a data set of a user's online behavior, and preprocessing the data set to obtain a preprocessed data set.

The data in the preprocessed data set includes attribute characteristics, granularity characteristics and particle label values.

The theory of granular computing mainly involves three concepts of granular computing: particle, granularity and granular layer, and the formal descriptions are given below:
description of particles: particles are the basic elements of the granular computing model, and a particle may be regarded as a collection of individual elements and the characteristic attributes in the data set aggregated according to certain rules or algorithms. In particular, a single data element may also be regarded as a particle.
description of granularity: granularity is the degree of data materialization or abstraction, which may be used to measure and describe the size of particles in the data after granulation, and may also be used as a quantitative rule to limit the size of data-generated particles in the granulation process. Granularity is often a reasonably limited interval range given according to the actual data scene. The granularity in the same granular layer is similar, but the granularity in different granular layers is quite different.
description of granular layer: from the data function point of view, a granular layer corresponds to an abstract perspective describing the calculated object, which may be used as a characteristic category of data; from the point of view of granular computing theory, a granular layer is a particle set composed of all particles granulated by a specified granulation rule. In particular, the initial granular layer is the original data set.

The concept of granularity in that application not only aggregates data hierarchically from bottom to top from the point of view of data storage, but also simulates the ability of human beings to recognize things abstractly. The first thing to do is to convert the data into a standard data format suitable for the application through data preprocessing, so that the data set has abstract multi-granularity characteristics and generates particle label values. Multi-granularity characteristics and the particle labels may be obtained by designing a data structure framework before collecting data. For example, when collecting online behavior records, the attributes of the account, department and company to which the online behavior data belongs are set, and these attributes may be used as multi-granularity characteristics. In addition, multi-granularity characteristics and particle label values may also be generated from the user's online behavior data set by hierarchical clustering.

In this embodiment, the “user online behavior data set” is taken as experimental data, which comes from the competition of “Analysis of abnormal behaviors of users online based on UEBA” under the Datafountain platform. The data description is shown in the following table, in which “account” and “group” are taken as the granularity characteristics of this data set:

TABLE 1
Data Description

| Field name | Field description |
|---|---|
| id | Log data record number |
| account | User account, desensitized. |
| group | User ownership department |
| IP | Terminal IP |
| url | Terminal internet address |
| port | Terminal internet application port |
| vlan | The virtual network domain |
| | number where the terminal is |
| | located. |
| switchIP | Terminal connection switch IP |
| time | Time when terminal surfing |
| | behavior occurs. |
| ret | Abnormal behavior evaluation |
| | score |

Table 2 shows the data set style obtained after preprocessing the data set of users' online behavior:

TABLE 2
Data set style obtained after data preprocessing

| | Attribute | | | | | | | | | | | | |
|---|---|---|---|---|---|---|---|---|---|---|---|---|---|
| | characteristics T | | | | | | Granularity characteristics M | | | | | | |
| NO. | T₁ | T₂ | . . . | T_{q} | . . . | T_{Q} | M₁ | M₂ | . . . | Mₖ | . . . | M_{K} | Label |
| 1 | 3 | 7 | . . . | A1 | . . . | B2 | X1 | Y1 | . . . | Z | . . . | | 0.5 |
| 2 | 2 | 3 | . . . | A3 | . . . | B1 | X2 | Y1 | . . . | Z | . . . | | 0.8 |
| 3 | 4 | 5 | . . . | A2 | . . . | B3 | X2 | Y2 | . . . | Z | . . . | | 1 |
| . . . | . . . | . . . | . . . | . . . | . . . | . . . | . . . | . . . | . . . | | . . . | . . . | 0 |
| V | 6 | 5 | . . . | A1 | . . . | B5 | X9 | Y2 | . . . | Z | . . . | | 0.9 |

The serial number set {1,2,3, . . . , v, . . . , V} represents the serial number set of the data set; it is assumed that x_{vq} represent the q-th attribute characteristic value of the v-th data, xᵥₖ represents the k -th granularity characteristic value of the v -th data, T ={T₁, T₂, . . . , T_{q}, . . . , T_{Q}} is the set of attribute characteristics, M={M₁, M₂, . . . , Mₖ, , . . . , M_{K}} is the set of granularity characteristics. For example, M₁ stands for the granularity characteristics of “Account” granular layer, M₂ stands for the granularity characteristics of “Department” granular layer and M₃ stands for the granularity characteristics of “Company” granular layer. The numbers under the T₁ and T₂ characteristics in the table indicate that they are numerical characteristics, the symbols under the T_{q} and T_{Q} characteristics indicate that they are symbolic characteristics, M₁ indicates the finest granular layer abstracted from the data set, M₂ indicates the granular layer with larger granularity than M₁, and so on, until the maximum granular level required for solving the problem is met, where 1≤k≤K, |Gᵢ≥1.

S104, inputting the preprocessed data set into a pre-designed multi-granularity perception data derivation algorithm, performing multi-granularity perceptionsing processing on the derivative data set according to the characteristic categories of attribute characteristics and particle label values through the multi-granularity perception data derivation algorithm to obtain a multi-granularity perception data set, and dividing the multi-granularity perception data set according to the granularity characteristics in layers to obtain a multi-level derivative data set.

The derivative data sets are divided into training data sets and testing data sets; the data in the derivative data set include the derivative attribute values and the particle label values of the corresponding granular layers.

Multi-granularity perception Data Derivation Algorithm (MPDDA) algorithm essentially provides data diversity, which simulates the process of human cognition of the world, and deeply cognizes the data from multi-granularity perspectives and different particle structure perspectives, so that the model of the application has the interpretability on the data, and the differentiated data processed and derivative based on the granularity characteristics and particle structure of the data is beneficial to computer cognition and learning.

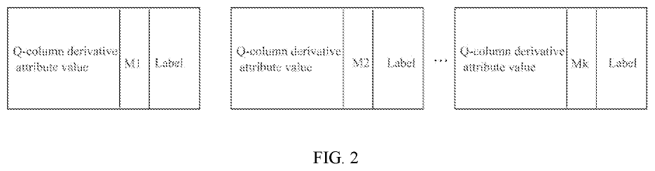

FIG. 2 shows the derivative data style output by the multi-granularity perception data derivation algorithm.

The data derivative from the original data set include three categories: Q-column attribute values, particle labels Mᵢ corresponding to granular layers, and result label values. Particle label Mᵢ will be trained and learned by the model as an important characteristic together with derivative attribute values, and it is the retention of particle label values that makes other derivative attribute values meaningful. In the data generated by practical problems, the numerical value derivative from some characteristics through multi-granularity perception is meaningless and unexplained, and only when the characteristics appear in the training set together with the granularity characteristics may the characteristics be interpreted for training. The result label value of this embodiment represents the abnormal degree of online behavior, and the result label value is applied to supervised learning tasks as an optimization goal.

S106, training a plurality of preset base learners according to the derivative attribute values of the training data set data and the particle label values of the corresponding granular layers to obtain a trained base learner based on a base learning algorithm, and the trained base learners are obtained.

The number of base learners is the same as the layer number of derivative data sets.

The base learner in the application may be homogeneous or heterogeneous, and different base learners may be selected according to the actual situation in the application process. The input data of the base learner consist of K derivative data sets. Especially when k=1, the attribute characteristics of this data set are the same as those of the preparatory data set. Because the granularity characteristic is that the data number of the data set may not promote the better learning of the model, the granularity characteristic M₁ is not added in the process of training the first layer derivative training set.

In the actual process of data processing, it is found that the eigenvalues of some characteristics generated by multi-granularity perception data derivation algorithm deviate from the corresponding original characteristic connotations, which makes the characteristics difficult to understand, and only bind with the granularity characteristics from which they are derivative to form new connotations. Based on this, it is needed to specify that the base learner may be a tree model, and the global normalization operation may be omitted when preprocessing the data for the tree model.

S108, inputting the training data set into the trained base learner, calculating a self-prediction error of the testing data set predicted by the trained base learner, and counting a mean square error with particle as unit and a mean square error with granular layer as a unit according to the self-prediction error.

The self-prediction error is calculated by the result label value of the training data set and the output result of the base learner.

The premise that the particle weights obtained from the training data set may be reused in the testing set is that the particle label set of each granular layer in the testing set is the complete set of particle labels of each granular layer in the data set of users' online behavior.

S110, obtaining the particle-level weight according to the mean square error with the particle as the unit, obtaining the granularity-level weight according to the mean square error with the granular layers as the unit, and determining the weight information according to the particle-level weight and the granularity-level weight.

The application provides a weighted integration strategy based on particle mean square error (MSE) optimization. Particle weighting mechanism is to optimize and adjust the prediction effect of each base learner by giving weights to particles in different granular layers, and the particle structure with good prediction effect will be given greater weight, otherwise it will be given less weight. The data objects in each particle share the weight, which may reduce the computational complexity and the possibility of over-fitting. Essentially, the weighted integration strategy of the application optimizes the model from the particle visual field and particle layer perspective.

S112, inputting the testing data set into the trained base learner to obtain the prediction results of the testing data set, and performing weighted integration on the prediction results according to the weight information to output the multi-granularity perception integrated learning prediction results of the user's online behavior data.

In the multi-granularity perception integrated learning method, a preprocessed data set including attribute characteristics, granularity characteristics and particle label values is obtained by preprocessing the data set of online behaviors of users; performing multi-granularity perceptionsing processing on the derivative data set according to the characteristic categories of attribute characteristics and particle label values through the multi-granularity perception data derivation algorithm, and then the data is divided into granular layers according to the granularity characteristics to obtain multi-level derivative data sets; based on the base learning algorithm, a plurality of preset base learners are trained according to the derivative attribute values of the training data set data in the derivative data set and the particle label values of the corresponding granular layers, and the trained base learners are obtained; inputting the training data set into the trained base learner, calculating the self-prediction error, and counting the mean square error with the particle as the unit and the mean square error with the granular layer as the unit; determining the weight information according to the error of particles and granular layers; wherein, the smaller of the values of the particles or granular layers, the larger the weight values; inputting the testing data set into the trained base learner to obtain the prediction results of the testing data set, and then carrying out weighted integration on the prediction results according to the weight information to output the multi-granularity perception integrated learning prediction results of the user's online behavior data. According to the user's online behavior data, the application proposes to transform the user's online behavior data from particle visual field and particle layer perspective to derive a plurality of data sets with different visual fields, and divides the weights into two levels through weighted integration strategy: granular layer and particle, thus improving the interpretability of the user's online behavior analysis and the accuracy of the prediction results.

In one embodiment, the method further includes the following steps: obtaining the data set of the user's online behavior, and preprocessing the data set; generating the attribute characteristics, the granularity characteristics and the particle label values of data according to attributes in the data structure of the data set to obtain the preprocessed data set; the attributes in the data structure of the data set is an account, a department and a company to which the data belongs; or generating the attribute characteristics, the granularity characteristics and the particle label values of data according to the data set through a hierarchical clustering method to obtain the preprocessed data set.

In one embodiment, that method further includes: inputting the preprocessed data set into a pre-designed multi-granularity perception data derivation algorithm; taking the particle label value as one of the attribute characteristics, the attribute characteristics of the preprocessed data are discriminated. If the attribute characteristics are numerical characteristics, the numerical characteristics are normalized within particles, and if the attribute characteristics are symbolic characteristics, the symbolic characteristics are recoded within particles; and a multi-granularity perception data set is obtained. the multi-granularity perception data set is divided into a multi-granularity training set and a multi-granularity testing set; according to the granularity characteristics, the multi-granularity training set and the multi-granularity testing set are divided according to the granular layer, and the multi-level training data set and the multi-level testing data set are obtained respectively; the training data set and the testing data set constitute a derivative data set.

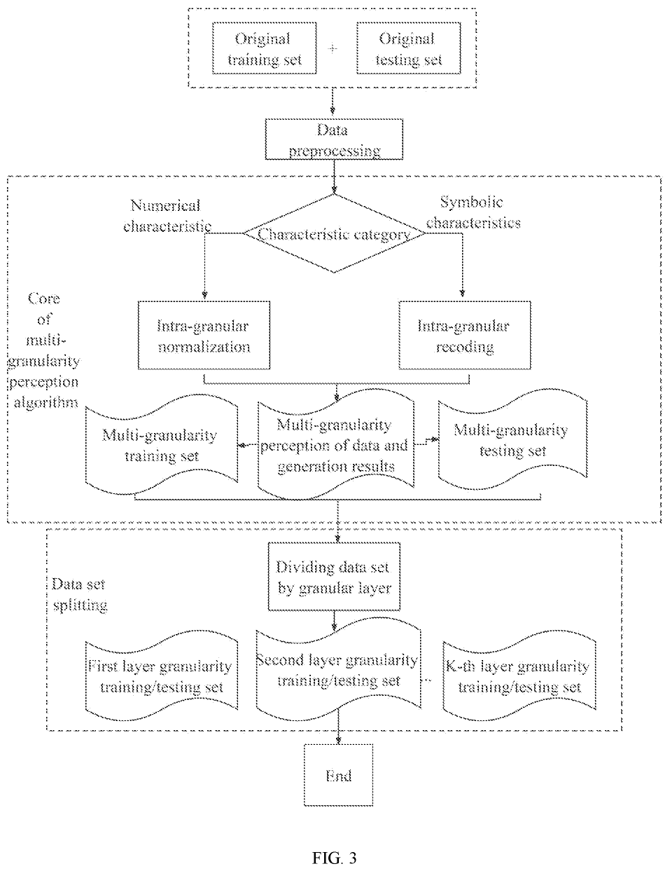

Specifically, the flow chart of the multi-granularity perception data derivation algorithm is shown in FIG. 3. Firstly, the training set and the testing set are aggregated together, and the preliminary data preprocessing and characteristic category determination are carried out, and the numerical characteristics are normalized within particles, and the discrete characteristics are recoded within particles, and then the multi-granularity perception results are generated. Finally, the multi-granularity training set and the multi-granularity testing set are divided into k training sets and k testing sets according to granular layers respectively.

Intra-granular normalization operation for numerical characteristics and intra-granular recoding for symbolic characteristics are the core algorithms of multi-granularity perception data derivation. The main functions are to realize multi-level perception of data sets through multi-granularity data derivation, and the essence is to normalize or recode the data sets in units of particles, which is equivalent to each particle forming its own system, so that computers may distinguish each data more accurately at each particle level. The subsequent data derivation process is equivalent to expanding the derivative data set corresponding to the granular layer based on the original data set, providing more data and perspectives for the next machine learning.

\textcircled{1}Intra-granular normalization: the traditional normalization is only a dimensionless method of linear transformation of data, which may accelerate the gradient descent speed of some machine learning algorithms, but intra-granular normalization is more than that. Intra-granular normalization frames the normalized data range within particles in different granular layers, and the numerical characteristics in all particles under each granular layer should be normalized separately, so as to achieve the data processing purpose of multi-granularity perception of numerical characteristics.

\textcircled{2}Intra-granule recoding: intra-granule recoding is aimed at the symbolic characteristics in the data set, and it is carried out inside each granule in different granule layers of the universe. There are two common coding methods in data processing, One-hot Encoding and Label Encoding. Single-hot coding is suitable for non-tree models whose loss function is sensitive to numerical changes, such as logistic regression and SVM. Label coding is suitable for tree models whose loss function is insensitive to numerical changes, such as RF, GBDT, etc. Therefore, it is necessary to judge the type of machine learning model before selecting coding rules. The data processing objective of intra-granular recoding is to realize multi-granularity perception of symbolic characteristics.

The detailed flow of the multi-granularity perception data derivation algorithm, i.e. pseudo code, is shown in Algorithm 1:

```
Algorithm 1: MPDDA
Input: preliminary data;
Output: K training sets train_dataₖ and testing sets test_dataₖ, k in [1, K];
/* dataₖ represents a data set derived from data through granularity
granulation at the k-th layer;
i ∈ {Mₖ}, which represents the particle label of the k-th granular layer in
dataₖ. */
Initialize parameters: x_{q}′, dataₖ
data₁ = data\{M₂, M₃, . . . , M_{K}}
Split data₁ to train_data₁ & test_data₁
for k in (1, K] do
  | for T_{q} in T do
  | | if type(x_{q}) = = srt do
  | | | for i in {Mₖ}
  | | | | x_{q}′[i] = x_{q}[i].reset_index( ).tolist( )
  | | | /*
  | |  Reset the index of the q-column eigenvalue list x_{q}[i] with particle
    label
  | | i and store it in the new list as the new characteristic code x_{q}′[i]. */
  | | x_{q}′ ← x_{q}′[i]
  | | /* The characteristic codes x_{q}′[i] are sequentially stored in the new
    list x_{q}′.
  | | */
  | | end for
  | else
for i | in Mₖ
    | | ${x}_{q}^{′} [ i ] = \frac{{x}_{q} [ i ]}{{max}_{i} ( {x}_{q} )}$
    | x_{q}′ ← x_{q}′[i]
end for
dataₖ ← x_{q}′ /*Adding the derived characteristic column x_{q}′ to the data set
dataₖ.
dataₖ ← {Mₖ} /*Adding granularity characteristic column Mₖ to data set
dataₖ.
Split dataₖ to train_dataₖ & test_dataₖ
end for
```

One embodiment further includes: taking the weight information as the initial value of the particle swarm algorithm; iterating repeatedly through particle swarm optimization according to the initial value until the end condition is met, and end the iteration; obtaining the enhanced weight information; inputting a testing data set into a trained base learner to obtain the prediction results of the testing data set; according to the enhanced weight information, the prediction results are weighted and integrated.

This embodiment provides an enhancement strategy based on particle swarm optimization. If the accuracy is high, but the training time is not high, the initial weighting strategy may be obtained by the method based on granular MSE optimization, which may be used as the initial input value of particle swarm optimization to speed up the optimization process, and the enhanced weighted integration strategy may be obtained after repeated iterations.

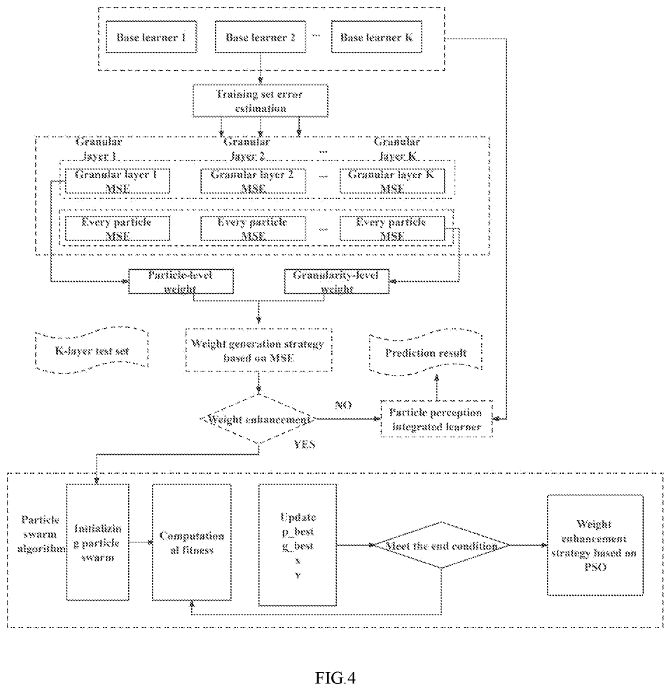

Specifically, FIG. 4 is a granular weighted integration strategy with enhanced weights, including following steps:
S1 (training set error estimation): set K training sets as verification sets, verify K base learners respectively, and calculate the prediction variance of each data. ŷ_{k,v} represents the prediction value of the k-th base learner for the v-th object, and SE_{k,v} represents the prediction variance of the k-th base learner for the v-th object.

SE_{k,v}=(ŷ_{k,v}−yᵥ)²

S2 (Particle Error Statistics): calculating the mean square error MSE in the unit of particles to measure the average prediction deviation of particles, where m_{k,v} represents the particle label, the particle characteristic value of the v-th data in the k -th granular layer, ID (m_{k,v}) represents the numbered set of data in the k-th granular layer that are the same as the particle label of the v-th data, Gᵢ^{k} may be the i-th particle in the k-th granular layer, |Gᵢ^{k}| may be understood as the number of data in the particle, and may also be understood as the granularity, so the mean square error of the particle visual field is as follows:

$$M S {E}_{{G}_{i}^{k}} = \frac{{\sum }_{ν ∈ {G}_{i}^{k}} S {E}_{k , ν}}{\vert {G}_{i}^{k} \vert} , k \geq 2 ;$$

S3 (granular layer error statistics): estimating the prediction deviation of the model from the perspective of granular layer, and also referring to the index of mean square error MSE. If the total data volume of each training set is V, the mean square error MSEₖ of granular layer perspective may be expressed as follows:

$$M S {E}_{k} = \frac{1}{\vert V \vert} {\sum }_{v ∈ V} S {E}_{k , v} ;$$

S4 (MSE-based weight generation strategy): Obviously, the larger the values of MSE_{k,v} and MSEₖ, the worse the prediction effect of the base learner in the range of particle v or granular layer k. Therefore, the particles and granular layers with large mean square error are given smaller weights, while the particles and granular layers with small values are given larger weights, so as to enhance the overall prediction effect of the model. It should be noted that the first layer is the original data set, and there is no abstract particle structure, so there is no need to calculate particle weights. The granular layer base learner with k≥2 is given the weight w₂ as a cognitive whole, while the granular layer base learner with k=1 is given the weight w₁ as a whole. Particle weight w_{k,v} and granular layer weight wₖ are respectively expressed as follows:

$$\begin{matrix}{w}_{k , v} = \frac{1 / MS {E}_{k , v}}{{\sum }_{k = 2}^{K} ( 1 / MS {E}_{k , v} )} , k \geq 2 \\ {w}_{1} = \frac{1 / MS {E}_{k}}{{\sum }_{k = 2}^{K} ( 1 / MS {E}_{k} )} , k = 1 \\ {w}_{2} = 1 - \frac{1 / MS {E}_{k}}{{\sum }_{k = 2}^{K} ( 1 / MS {E}_{k} )} , k = 1\end{matrix} .$$

The weight generation strategy based on MSE has the advantages of fast calculation speed and low calculation complexity. Meanwhile, this embodiment gives another weight enhancement strategy based on particle swarm optimization (as shown in S5), which may improve the prediction effect again, but the calculation complexity increases, so it may be decided whether to adopt this enhancement strategy according to the actual problem, and if not, skip to S6 (weighted integration) directly.

S5 (Weight enhancement strategy based on particle swarm optimization): obviously, the weight generation strategy based on MSE in the above S4 is mathematically provable and interpretable, but it may not be able to optimize the ensemble learning model to the most ideal state. Therefore, an optional weight enhancement step is given here, and the particle swarm algorithm is adopted to find the optimal weight distribution strategy of particles and granular layers. In the D-dimensional search space, assuming there are N particles, each particle represents a weight allocation strategy (w_{1,1}), then X_{id}=(xᵢ₁, xᵢ₂, . . . , x_{iD}) represents the position of the i-th particle, V_{id}=(vᵢ₁, vᵢ₂, . . . , v_{iD}) represents the speed of the i-th particle, the individual optimal solution searched by the i-th particle is P_{id,pbest}=(pᵢ₁, pᵢ₂, . . . , p_{iD}), the group optimal solution is P_{d,gbest}=(p_{1,gbest}, p_{2,gbest}, . . . , P_{D,gbest}) fₚ represents the individual historical optimal fitness value, and f_{g} represents the group historical optimal fitness value.

The core calculation formulas in the whole particle algorithm are velocity update formula x_{id}^{s+1}, position update formula x_{id}^{s+1} and fitness function f, which are respectively expressed as follows:

$$\begin{matrix}\{ \begin{matrix}{v}_{i d}^{s + 1} = ω {v}_{i d}^{s} + {c}_{1} {r}_{1} ( {p}_{i d , p b e s t}^{s} - {x}_{i d}^{s} ) + {c}_{2} {r}_{2} ( {p}_{i d , g b e s t}^{s} - {x}_{i d}^{s} ) \\ {x}_{i d}^{s + 1} = {x}_{i d}^{s} + {v}_{i d}^{s + 1}\end{matrix} \\ f = 1 - 1 / ( \sqrt{{\sum }_{v = 1}^{V} {( {y}_{v}^{*} - {y}_{v} )}^{2} / \vert V \vert} + 1 )\end{matrix} ;$$

Where s represents the number of iterations, ω is the inertia weight, c₁ is the individual learning factor, and c₂ is the group learning factor; r₁ and r₂ are random numbers within [0,1].

S6 (Weighted integration): after using the trained base learners to predict, the output results are combined with the particle weights to complete the final integration calculation, and the symbol [symbol] is used to represent the learning results of multi-granularity perception integration:

[symbol]

= [symbol] ·w₁+(Σₖ₌₂^{K}( [symbol] ·w_{k,v}))·(1−w₁).

It should be understood that although the steps in the flowchart of FIG. 1 are shown in sequence as indicated by arrows, these steps are not necessarily executed in sequence as indicated by arrows. Unless explicitly stated in this article, the execution of these steps is not strictly limited in order, and these steps may be executed in other orders. Moreover, at least a part of the steps in FIG. 1 may include multiple sub-steps or multiple stages, which may not necessarily be completed at the same time, but may be executed at different times, and the execution order of these sub-steps or stages may not necessarily be sequentially executed, but may be alternately or alternatively executed with other steps or at least a part of sub-steps or stages of other steps.

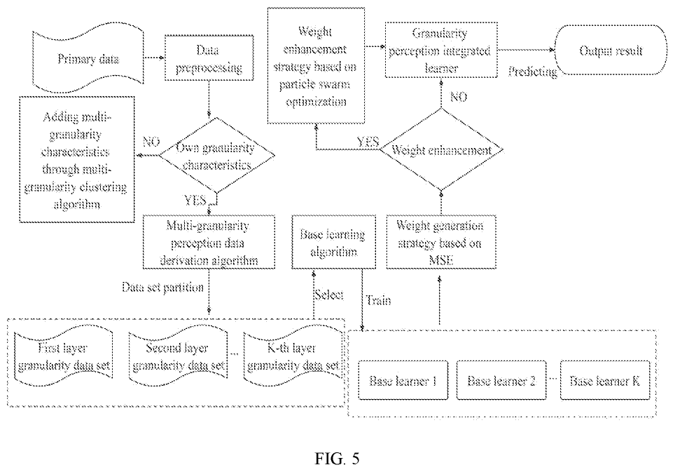

In another embodiment, as shown in FIG. 5, the architecture of a multi-granularity perception integrated learning method is provided. Firstly, the original data set is input, and the conventional data preprocessing operation is performed, and then it is judged whether the data has its own granularity characteristics. If not, appropriate granularity characteristics need to be added based on hierarchical clustering algorithm. So far, the data sets with multi-granularity characteristics are processed by multi-granularity perception data derivation algorithm, and the output results are K preliminary training sets. Then, the appropriate base learning algorithm is selected for training, and K base learners are obtained. The training sets are predicted by the K base learners respectively, and then the self-prediction error of the training sets is calculated, and the MSE and MSE of each granular layer are counted by the unit of particle structure. The larger the MSE, the greater the prediction deviation of base learner in the particle structure or granular layer, so the particles or granular layer with large MSE value may be given less weight to weaken the bad prediction effect. The weighted integration strategy based on particle MSE optimization is obtained. However, this weighting strategy is not necessarily the best. If there is a higher accuracy requirement, try to perform weight enhancement with the weighted integration strategy based on particle swarm optimization, and get the final particle perception integrated learner. Finally, the particle perception integrated learner is used to predict the task.

In a specific embodiment, the “data set of users' online behavior” as shown in Table 1 above is used as experimental data.

Scoring rules are based on RMSE Score, and the higher the value, the better the prediction effect of the model:

$$\begin{matrix}RMSE = \sqrt{\frac{{\sum }_{i = 1}^{n} {( {X}_{\{ True value} - {X}_{Predicted value} )}^{2}}{n}} \\ Score = \frac{1}{R M S E + 1}\end{matrix} .$$

The experimental equipment is run by intel i7 32G CPU, and the programming language is Python3.8. LightGBM, XGBoost and random forest are used to add into the Multi-Granularity Perceptual Ensemble Learning (GEL) framework for comparative experiments.

In the experiment, three base learners are used to train and predict six patterns:
\textcircled{1} training and forecasting a single granularity respectively;
\textcircled{2} training and predicting the data with original granularity by using K-Fold mode, where K=3, the number of granular layers;
\textcircled{3} connecting the data sets with three granularity as a data set for training and forecasting respectively;
\textcircled{4} after training the single granularity separately, the average weighted pattern integration is adopted;
\textcircled{5} adopting GEL mode based on Mean Squared Erro (MSE) optimization weighting; \textcircled{6} adopting GEL mode based on Partical Swarm Optimization (PSO) enhanced weighting.
In the experiment, the parameters of each model are consistent in the above six experiments. Table 3 gives the parameter settings used in training, if the parameter setting is not given, it is the default parameter of the model.

TABLE 3
Parameter Settings

| | | | Random |
|---|---|---|---|
| Parameter | LightGBM | XGBoost | forest |
| n_estimators | 300 | 300 | 300 |
| max_depth | 15 | 15 | 15 |
| learning_rate | 0.1 | 0.1 | 0.1 |
| metric | RMSE | RMSE | RMSE |
| test_size | 0.2 | 0.2 | 0.2 |
| bootstrap | null | null | TRUE |
| early_stopping_rounds | 50 | 50 | null |
| n_jobs | −1 | −1 | −1 |

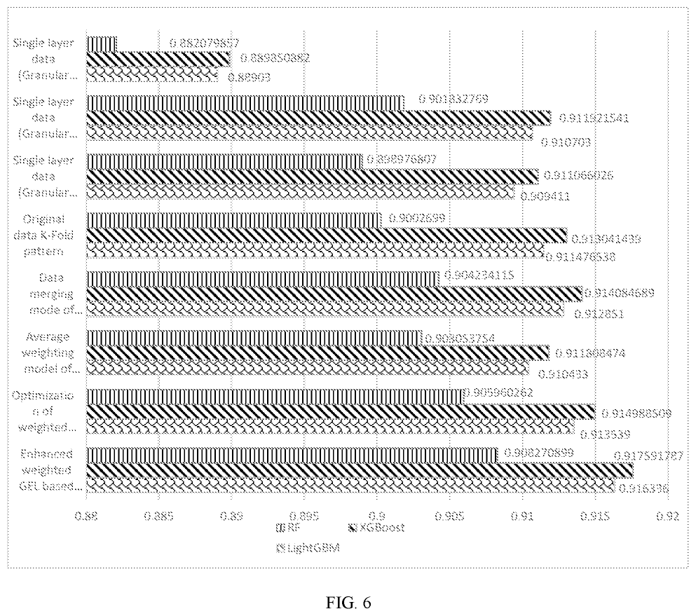

The experimental results are shown in FIG. 6. The model of the method provided by the application is recorded as GEL, and the experimental results are analyzed as follows:

First of all, it can be found that in all the experimental results, the prediction effect is XGBoost>LightGBM>Random Forest.

Secondly, in the drawings, single-layer data (granular layer 1) refers to the original data set, while single-layer data (granular layer 2, 3) refers to the data set generated by the multi-granularity perception derivation algorithm. By observing the prediction accuracy of these three data sets using three kinds of base learners respectively, it can be found that the performance of the learner in single-layer data (granular layer 2) is better than that in single-layer data (granular layer 1), which shows the feasibility of using the multi-granularity perception derivation algorithm for data derivation. However, the performance on single-layer data (granular layer 2) is very poor, which shows that the data sets obtained by multi-granularity perceptionsing derivative algorithm may not all achieve good results on the learner.

Finally, the prediction effects of different integration modes are compared. Enhanced weighted GEL based on PSO>optimized weighted GEL based on MSE>data merging mode of each granular layer>original data K-Fold mode>average weighted mode of each granular layer.

On the whole, the effect of particle-weighted inheritance strategy in GEL is better than other integration methods, and the enhanced strategy based on PSO does make GEL have better prediction effect.

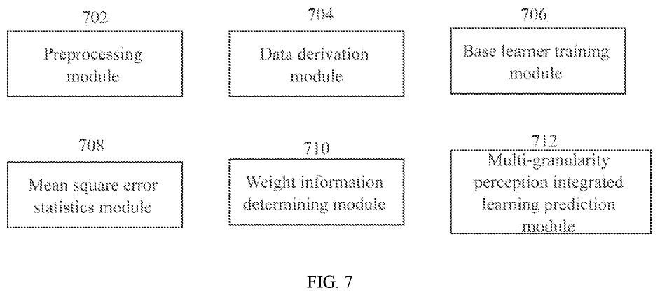

In one embodiment, as shown in FIG. 7, a multi-granularity perception integrated learning device is provided, which includes a preprocessing module 702, a data derivation module 704, a base learner training module 706, a mean square error statistics module 708, a weight information determining module 710 and a multi-granularity perception integrated learning prediction module 712, wherein:
a preprocessing module 702 is used for obtaining the data set of the online behaviors of users and preprocessing the data set to obtain the preprocessed data set; the data in the preprocessed data set includes the attribute characteristics, the granularity characteristics and the particle label values;
a data derivation module 704 is use for inputting the preprocessed data set into the pre-designed multi-granularity perception data derivation algorithm, and performing the multi-granularity perception processing on the preprocessed data set according to the characteristic category of the attribute characteristics and the particle label values by the multi-granularity perception data derivation algorithm to obtain the multi-granularity perception data set; dividing the multi-granularity perception data set by the granular layer according to the granularity characteristics to obtain the multi-level derivative data set; the derivative data set is divided into the training data set and the testing data set; the data in the derivative data set include the derivative attribute values and the particle label values of the corresponding granular layers;
a base learner training module 706 is used for training a plurality of preset base learners according to the derivative attribute values of the training data set data and the particle label values of the corresponding granular layers to obtain the trained base learner based on the base learning algorithm; the number of the base learners is the same as the number of layers of the derivative data set;
a mean square error statistics module 708 is used for inputting the training data set into the trained base learner, calculating the self-prediction error of the testing data set predicted by the trained base learner, and counting the mean square error with the particle as the unit and the mean square error with the granular layer as the unit according to the self-prediction error;
a weight information determining module 710 is used for obtaining the particle-level weight according to the mean square error with the particle as the unit, obtaining the granularity-level weight according to the mean square error with the granular layers as the unit, and determining the weight information according to the particle-level weight and the granularity-level weight; wherein, the smaller of the values of the particles or granular layers, the larger the weight values;
a multi-granularity perception integrated learning prediction module 712 is used for inputting the testing data set into the trained base learner to obtain the prediction results of the testing data set, and performing the weighted integration on the prediction results according to the weight information, and outputting the multi-granularity perception integrated learning prediction results for the user's online behavior data.

The preprocessing module 702 is also used for obtaining the data set of the user's online behavior, and preprocessing the data set; generating the attribute characteristics, the granularity characteristics and the particle label values of data according to attributes in the data structure of the data set to obtain the preprocessed data set; the attributes in the data structure of the data set is a account, a department and a company to which the data belongs; or generating the attribute characteristics, the granularity characteristics and the particle label values of data according to the data set through a hierarchical clustering method to obtain the preprocessed data set.

The data derivation module 704 is also use for inputting the preprocessed data set into a pre-designed multi-granularity perception data derivation algorithm; taking the particle label value as one of the attribute characteristics, the attribute characteristics of the preprocessed data are discriminated. If the attribute characteristics are numerical characteristics, the numerical characteristics are normalized within particles, and if the attribute characteristics are symbolic characteristics, the symbolic characteristics are recoded within particles; and obtaining a multi-granularity perception data set.

The data derivation module 704 is also used to divide the multi-granularity perception data set into a multi-granularity training set and a multi-granularity testing set; according to the granularity characteristics, the multi-granularity training set and the multi-granularity testing set are divided according to the granular layer, and the multi-level training data set and the multi-level testing data set are obtained respectively; the training data set and the testing data set constitute a derivative data set.

The base learner training module 706 is also used for enhancing the weight information through the particle swarm algorithm to obtain the enhanced weight information; inputting a testing data set into a trained base learner to obtain prediction results of the testing data set; according to the enhanced weight information, the prediction results are weighted and integrated.

The base learner training module 706 is also used to take the weight information as the initial value of the particle swarm algorithm; iterate repeatedly through particle swarm optimization according to the initial value until the end condition is met, and end the iteration; and the enhanced weight information is obtained.

For the specific definition of the multi-granularity perception integrated learning device, please refer to the definition of the multi-granularity perception integrated learning method above, which is not repeated here. Each module in the multi-granularity perception integrated learning device may be realized in whole or in part by software, hardware and their combinations. The above modules may be embedded in or independent of the processor in the computer equipment in the form of hardware, and may also be stored in the memory in the computer equipment in the form of software, so that the processor may call and execute the operations corresponding to the above modules.

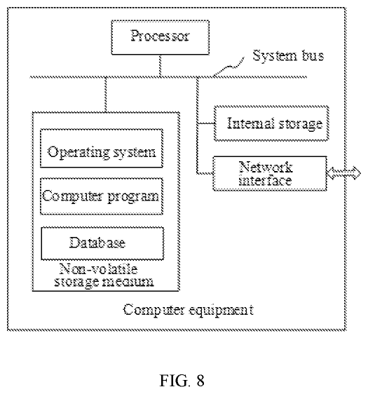

In one embodiment, a computer device is provided, which may be a terminal, and its internal structure diagram may be as shown in FIG. 8. The computer equipment includes a processor, a memory, a network interface, a display screen and an input device connected through a system bus. The processor of the computer device is used for providing computing and control capabilities. The memory of the computer device includes a non-volatile storage medium and an internal memory. The non-volatile storage medium stores an operating system and a computer program. The internal memory provides an environment for the operation of the operating system and computer programs in the non-volatile storage medium. The network interface of the computer equipment is used to communicate with external terminals through network connection. The computer program, when executed by a processor, realizes a multi-granularity awareness integrated learning method. The display screen of the computer equipment may be a liquid crystal display screen or an electronic ink display screen, and the input device of the computer equipment may be a touch layer covered on the display screen, a button, a trackball or a touchpad arranged on the shell of the computer equipment, and an external keyboard, touchpad or mouse.

It can be understood by those skilled in the art that the structure shown in FIG. 8 is only a block diagram of a part of the structure related to the scheme of the present application, and does not constitute a limitation on the computer equipment to which the scheme of the present application is applied. The specific computer equipment may include more or less components than those shown in the drawings, or combine some components, or have different component arrangements.

In one embodiment, a computer device is provided, which includes a memory and a processor, wherein the memory stores a computer program, and when the processor executes the computer program, the steps in the above method embodiment are realized.

In one embodiment, a computer-readable storage medium is provided, on which a computer program is stored, and the computer program, when executed by a processor, realizes the steps in the above method embodiment.

Those skilled in the art can understand that all or part of the processes in the method for realizing the above-mentioned embodiments may be completed by instructing related hardware through a computer program, which may be stored in a non-volatile computer-readable storage medium, and when executed, the computer program may include the processes of the above-mentioned embodiments. Any reference to memory, storage, database or other media used in the embodiments provided in this application may include non-volatile and/or volatile memory. The non-volatile memory may include read-only memory (ROM), programmable ROM(PROM), electrically programmable ROM(EPROM), electrically erasable programmable ROM(EEPROM) or flash memory. The volatile memory may include random access memory (RAM) or external cache memory. By way of illustration and not limitation, RAM is available in various forms, such as static RAM(SRAM), dynamic RAM(DRAM), synchronous DRAM(SDRAM), double data rate SDRAM(DDRSDRAM), enhanced SDRAM(ESDRAM), synchronous link DRAM (SLDRAM), rambus direct RAM(RDRAM), direct rambus dynamic RAM(DRDRAM), and rambus dynamic RAM(RDRAM).

The technical characteristics of the above embodiments may be combined at will. In order to make the description concise, not all possible combinations of the technical characteristics in the above embodiments are described. However, as long as there is no contradiction between the combinations of these technical characteristics, they should be considered as the scope recorded in this specification.

The above-mentioned embodiments only express several implementations of the present application, and their descriptions are more specific and detailed, but they cannot be understood as limiting the scope of application patents. It should be pointed out that for those skilled in the art, without departing from the concept of this application, several modifications and improvements may be made, which are within the protection scope of this application. Therefore, the scope of protection of the patent in this application shall be subject to the claims.

What is claimed is:

1. A multi-granularity perception integrated learning method, comprising:
obtaining a data set of a user's online behavior, and preprocessing the data set to obtain a preprocessed data set, wherein the data in the preprocessed data set comprises attribute characteristics, granularity characteristics and particle label values;
inputting the preprocessed data set into a pre-designed multi-granularity perception data derivation algorithm, and performing a multi-granularity perception processing on the preprocessed data set according to a characteristic category of the attribute characteristics and the particle label values by the multi-granularity perception data derivation algorithm to obtain a multi-granularity perception data set; and dividing the multi-granularity perception data set by a granular layer according to the granularity characteristics to obtain a multi-level derivative data set, wherein the derivative data set is divided into a training data set and a testing data set, and the data in the derivative data set comprise derivative attribute values and the particle label values of corresponding granular layers;
training a plurality of preset base learners according to the derivative attribute values of the training data set data and the particle label values of the corresponding granular layers to obtain a trained base learner based on a base learning algorithm; a number of the base learners is the same as a number of layers of the derivative data set;
inputting the training data set into the trained base learner, calculating a self-prediction error of the testing data set predicted by the trained base learner, and counting a mean square error with a particle as a unit and a mean square error with granular layer as a unit according to the self-prediction error;
obtaining a particle-level weight according to the mean square error with the particle as unit, obtaining a granularity-level weight according to the mean square error with granular layers as a unit, and determining weight information according to the particle-level weight and the granularity-level weight; wherein the smaller of the values of the particles or granular layers, the larger the weight values; and
inputting the testing data set into the trained base learner to obtain prediction results of the testing data set, performing weighted integration on the prediction results according to the weight information, and outputting a multi-granularity perception integrated learning prediction results for the user's online behavior data.

2. The method according to claim 1, wherein obtaining a data set of a user's online behavior, and preprocessing the data set to obtain a preprocessed data set, wherein the data in the preprocessed data set comprises attribute characteristics, granularity characteristics and particle label values, comprising:
obtaining the data set of the user's online behavior, and preprocessing the data set;
generating the attribute characteristics, the granularity characteristics and the particle label values of data according to attributes in the data structure of the data set to obtain the preprocessed data set, wherein the attributes in the data structure of the data set are an account, a department and a company of the data;
or generating the attribute characteristics, the granularity characteristics and the particle label values of the data according to the data set through a hierarchical clustering method to obtain the preprocessed data set.

3. The method according to claim 2, wherein inputting the preprocessed data set into a pre-designed multi-granularity perception data derivation algorithm, and performing a multi-granularity perception processing on the preprocessed data set according to a characteristic category of the attribute characteristics and the particle label values by the multi-granularity perception data derivation algorithm to obtain a multi-granularity perception data set, comprising:
inputting the preprocessed data set into the pre-designed multi-granularity perception data derivation algorithm; and
taking the particle label values as one of the attribute characteristics, judging the attribute characteristics of the preprocessed data; performing an intra-granular normalization on the numerical characteristics if the attribute characteristics are numerical characteristics, and performing an intra-granular recoding on the symbolic characteristics if the attribute characteristics are symbolic characteristics; and obtaining the multi-granularity perception data set.

4. The method according to claim 3, wherein the multi-granularity perception data set by a granular layer is divided according to the granularity characteristics to obtain a multi-level derivative data set; and the derivative data set is divided into a training data set and a testing data set, comprising:
dividing the multi-granularity perception data set into a multi-granularity training set and a multi-granularity testing set; and
dividing the multi-granularity training set and the multi-granularity testing set according to the granularity characteristics to obtain a multi-level training data set and a multi-level testing data set respectively; wherein the training data set and the testing data set constitute the derivative data set.

5. The method according to claim 4, wherein inputting the testing data set into the trained base learner to obtain the prediction results of the testing data set, and performing weighted integration on the prediction results according to the weight information, comprises:
enhancing the weight information through a particle swarm algorithm to obtain enhanced weight information;
inputting the testing data set into the trained base learner to obtain the prediction results of the testing data set; and
performing the weighted integration on the prediction results according to the enhanced weight information.

6. The method according to claim 5, wherein enhancing the weight information through a particle swarm algorithm to obtain enhanced weight information, comprises:
taking the weight information as an initial value of the particle swarm algorithm;
repeatedly performing an iteration the particle swarm algorithm according to the initial value until an end condition is met, and ending the iteration; and
obtaining the enhanced weight information.

7. The method according to claim 1, wherein the base learner is a tree model.

8. A multi-granularity perception integrated learning device, comprising:
a preprocessing module used for obtaining the data set of the online behaviors of users and preprocessing the data set to obtain the preprocessed data set, wherein the data in the preprocessed data set comprises attribute characteristics, granularity characteristics and particle label values;
a data derivation module used for inputting the preprocessed data set into a pre-designed multi-granularity perception data derivation algorithm, and performing multi-granularity perception processing on the preprocessed data set according to the characteristic category of the attribute characteristics and the particle label values by the multi-granularity perception data derivation algorithm to obtain the multi-granularity perception data set; dividing the multi-granularity perception data set by a granular layer according to the granularity characteristics to obtain a multi-level derivative data set; wherein the derivative data set is divided into a training data set and a testing data set; the data in the derivative data set comprises the derivative attribute values and the particle label values of the corresponding granular layers;
a base learner training module used for training a plurality of preset base learners according to the derivative attribute values of the training data set data and the particle label values of the corresponding granular layers to obtain the trained base learner based on the base learning algorithm, wherein a number of the base learners is the same as a number of layers of the derivative data set;
a mean square error statistics module used for inputting the training data set into the trained base learner, calculating a self-prediction error of the testing data set predicted by the trained base learner, and counting the mean square error with the particle as the unit and the mean square error with the granular layer as the unit according to the self-prediction error;
a weight information determining module used for obtaining particle-level weight according to the mean square error with the particle as the unit, obtaining the granularity-level weight according to the mean square error with the granular layers as the unit, and determining the weight information according to the particle-level weight and the granularity-level weight; wherein the smaller of the values of the particles or granular layers, the larger the weight values; and
a multi-granularity perception integrated learning prediction module used for inputting the testing data set into the trained base learner to obtain the prediction results of the testing data set, and performing the weighted integration on the prediction results according to the weight information, and outputting the multi-granularity perception integrated learning prediction results for users' online behavior data.

9. A computer device, comprising a memory and a processor, wherein a computer program is stored in the memory, and when the processor executes computer programs, steps of the method according to claim 1 is realized.

10. A computer-readable storage medium, wherein a computer program is stored on the computer-readable storage medium, and when the processor executes computer programs, the steps of the method according to claim 1 is realized.
